(19) United States
(12) Patent Application Publication
(10) Pub. No.: US 2005/0167951 A1
(43) Pub. Date: Aug. 4, 2005

(54) Stroller having skeleton with reduced width

(76) Inventor: Hui - Fen Zhen, Taichung (TW)

Correspondence Address: NIKOLAI & MERSEREAU, P.A., 900 SECOND AVENUE SOUTH, SUITE 820, MINNEAPOLIS, MN, 55402, US

(21) Appl. No.: 10/770,041

(22) Filed: Jan. 30, 2004

(51) Int. Cl. B62B 1/00

(52) U.S. Cl. 280/642

(57) ABSTRACT

A skeleton for a stroller includes a bottom frame, two oblique rods, a transverse rod, a wheel shaft, two rear wheels, two front support bars, and two rear support bars. Thus, the first ends of the two rear support bars are bent inward toward the mediate portion of the wheel shaft, so that each of the two rear wheels mounted on the wheel shaft is shifted inward and is flush with the second end of a respective one of the two rear support bars so as to reduce the distance between the two rear wheels, thereby greatly reducing the whole width of the skeleton of the stroller.

### BACKGROUND OF THE INVENTION

1. Field of the Invention

The present invention relates to a stroller, and more particularly to a stroller having a skeleton whose whole width is greatly reduced, thereby saving space of storage, movement and transportation.

2. Description of the Related Art

A conventional skeleton for a stroller 1 in accordance with the prior art shown in FIG. 1 comprises a bottom frame 10, a wheel shaft 13 mounted on a rear end of the bottom frame 10, two rear support bars 11 each mounted on the wheel shaft 13, and two rear wheels 12 each pivotally mounted on the wheel shaft 13. However, the rear wheels 12 are located outside of the rear support bars 11, so that the two rear wheels 12 protrude from the periphery of the skeleton, so that the whole width of the skeleton of the stroller is greatly increased, thereby occupying space of storage and transportation, and thereby causing inconvenience to the user when moving the stroller into a narrower site, such as a smaller elevator or the like.

### SUMMARY OF THE INVENTION

The primary objective of the present invention is to provide a stroller having a skeleton whose whole width is greatly reduced, thereby saving space of storage, movement and transportation.

Another objective of the present invention is to provide a stroller, wherein the skeleton of the stroller is folded completely so as to reduce the volume, thereby facilitating storage, package and transportation.

A further objective of the present invention is to provide a stroller, wherein the first ends of the two rear support bars are bent inward toward the mediate portion of the wheel shaft, so that each of the two rear wheels mounted on the wheel shaft is shifted inward and is flush with the second end of a respective one of the two rear support bars so as to reduce the distance between the two rear wheels, thereby greatly reducing the whole width of the skeleton of the stroller.

In accordance with the present invention, there is provided a skeleton for a stroller, comprising:
a bottom frame;
two oblique rods each having a lower end pivotally mounted on the front end of the bottom frame;
a transverse rod mounted on an upper end of each of the two oblique rods;
a wheel shaft mounted on a rear end of the bottom frame;
two rear wheels pivotally mounted on two ends of the wheel shaft;
two front support bars each having a first end mounted on the transverse rod; and
two rear support bars each having a first end mounted on the wheel shaft and a second end pivotally connected with a second end of a respective one of the front support bars;
wherein, each of the two rear wheels mounted on the wheel shaft is flush with the second end of a respective one of the two rear support bars, thereby greatly reducing the whole width of the skeleton of the stroller.

Further benefits and advantages of the present invention will become apparent after a careful reading of the detailed description with appropriate reference to the accompanying drawings.

### BRIEF DESCRIPTION OF THE DRAWINGS

FIG. 1 is a rear plan view of a conventional stroller in accordance with the prior art;

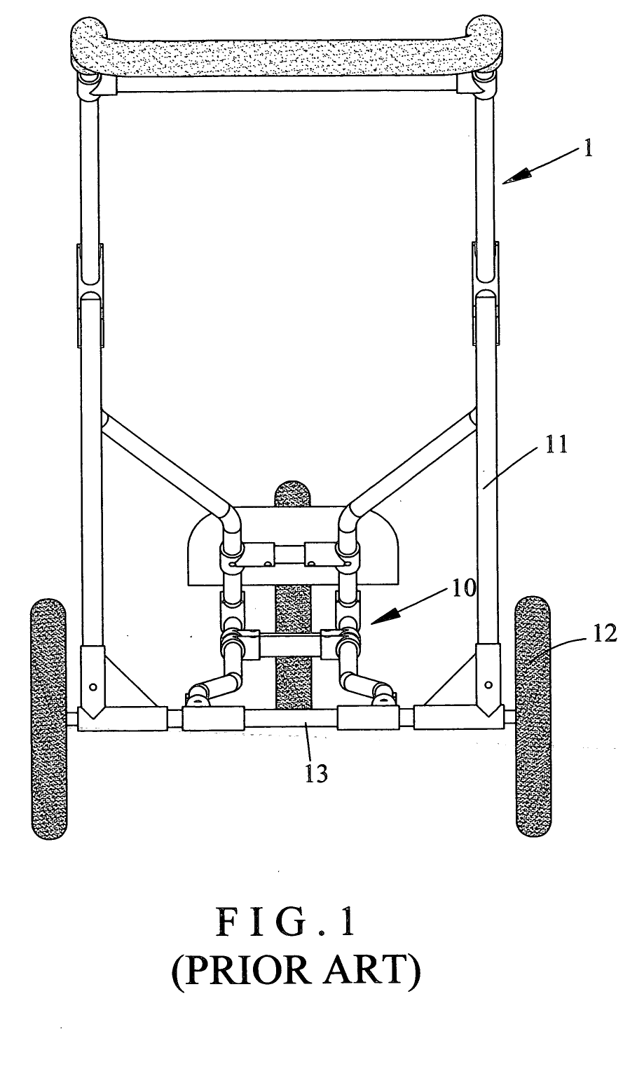

FIG. 2 is a perspective view of a stroller in accordance with the preferred embodiment of the present invention;

FIG. 3 is a bottom perspective view of the stroller in accordance with the preferred embodiment of the present invention;

FIG. 4 is a side plan view of the stroller as shown in FIG. 2;

FIG. 5 is a rear plan view of the stroller as shown in FIG. 2;

FIG. 6 is a schematic operational view of the stroller as shown in FIG. 4; and

FIG. 7 is a plan folded view of the stroller in accordance with the preferred embodiment of the present invention.

### DETAILED DESCRIPTION OF THE INVENTION

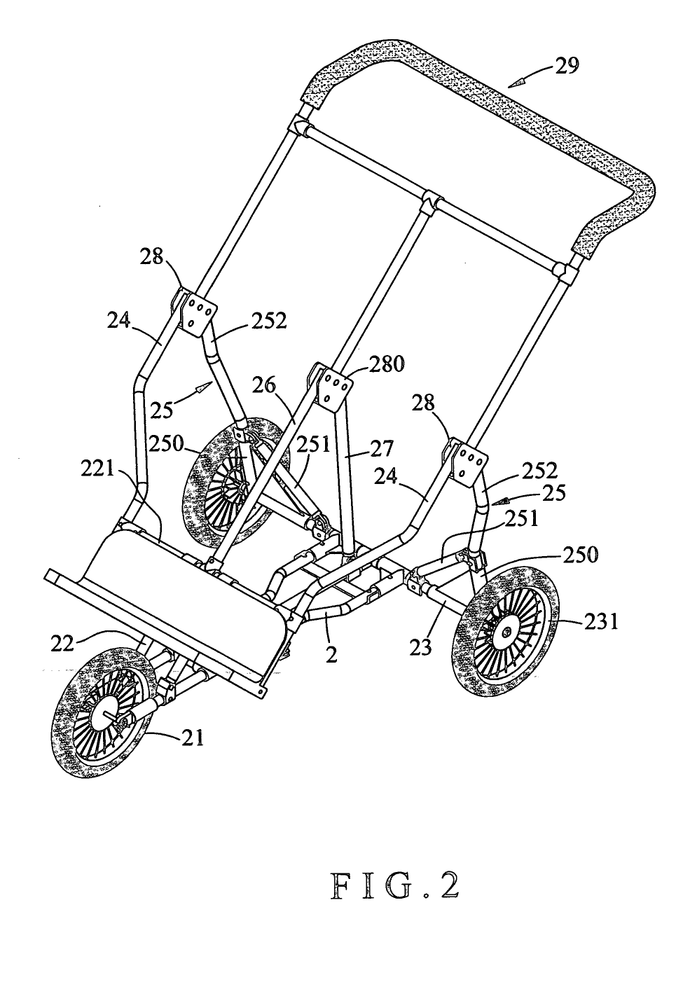

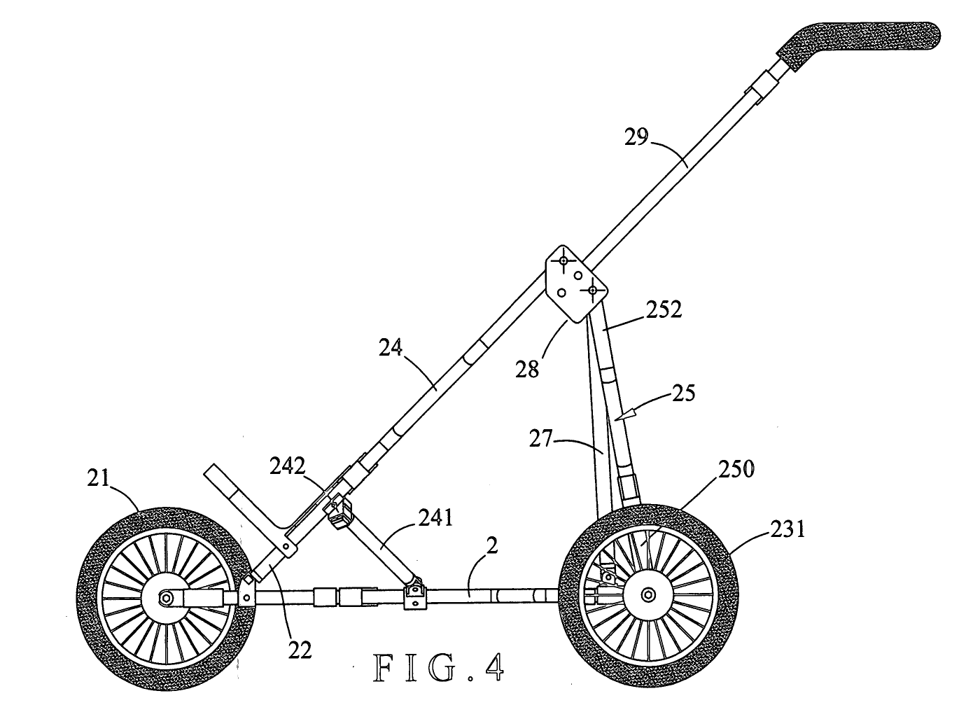

Referring to the drawings and initially to FIGS. 2-5, a skeleton for a stroller in accordance with the preferred embodiment of the present invention comprises a bottom frame 2, a front wheel 21 pivotally mounted on a front end of the bottom frame 2, two oblique rods 22 each having a lower end pivotally mounted on the front end of the bottom frame 2, a transverse rod 221 mounted on an upper end of each of the two oblique rods 22, a wheel shaft 23 mounted on a rear end of the bottom frame 2, two rear wheels 231 pivotally mounted on two ends of the wheel shaft 23, two front support bars 24 each having a first end mounted on the transverse rod 221, two rear support bars 25 each having a first end 250 mounted on the wheel shaft 23 and a second end 252 pivotally connected with a second end of a respective one of the front support bars 24 by a pivot base 28, a front support rod 26 having a first end mounted on the transverse rod 221, a rear support rod 27 having a first end mounted on the wheel shaft 23 and a second end pivotally connected with a second end of the front support rod 26 by a pivot base 280, and a push bar 29 mounted on the pivot base 28 and the pivot base 280.

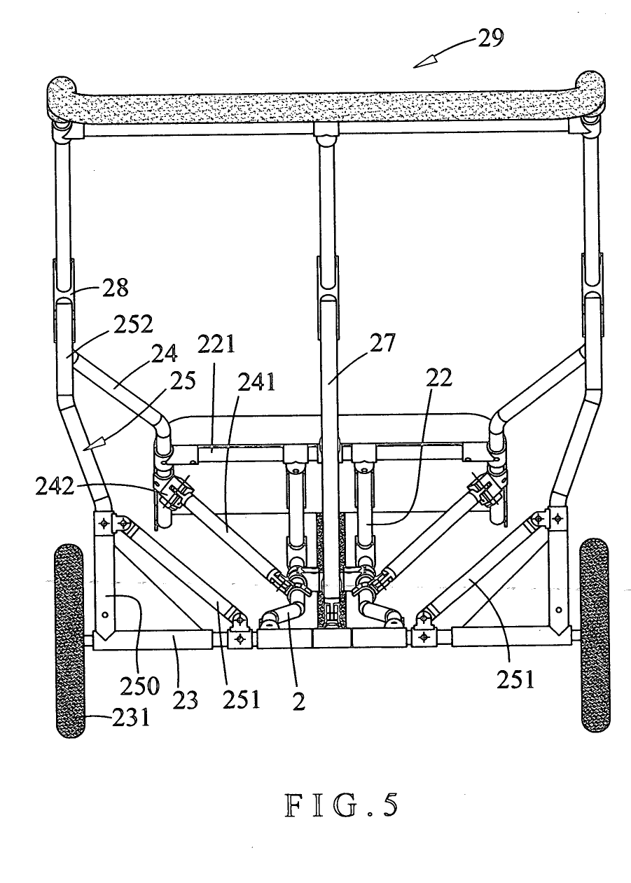

As shown in FIG. 5, the first ends 250 of the two rear support bars 25 are bent toward each other and are bent inward toward a mediate portion of the wheel shaft 23, so that each of the two rear wheels 231 mounted on the wheel shaft 23 is shifted inward and is flush with the second end 252 of a respective one of the two rear support bars 25, thereby greatly reducing the whole width of the skeleton of the stroller.

The skeleton further comprises two oblique rear stretchers 251 each pivotally mounted between the first end 250 of a respective one of the two rear support bars 25 and the mediate portion of the wheel shaft 23 to enhance the supporting effect of the two rear support bars 25.

The skeleton further comprises two oblique front stretchers 241 each pivotally mounted between a respective one of the two front support bars 24 and the bottom frame 2 to enhance the supporting effect of the front support bars 24.

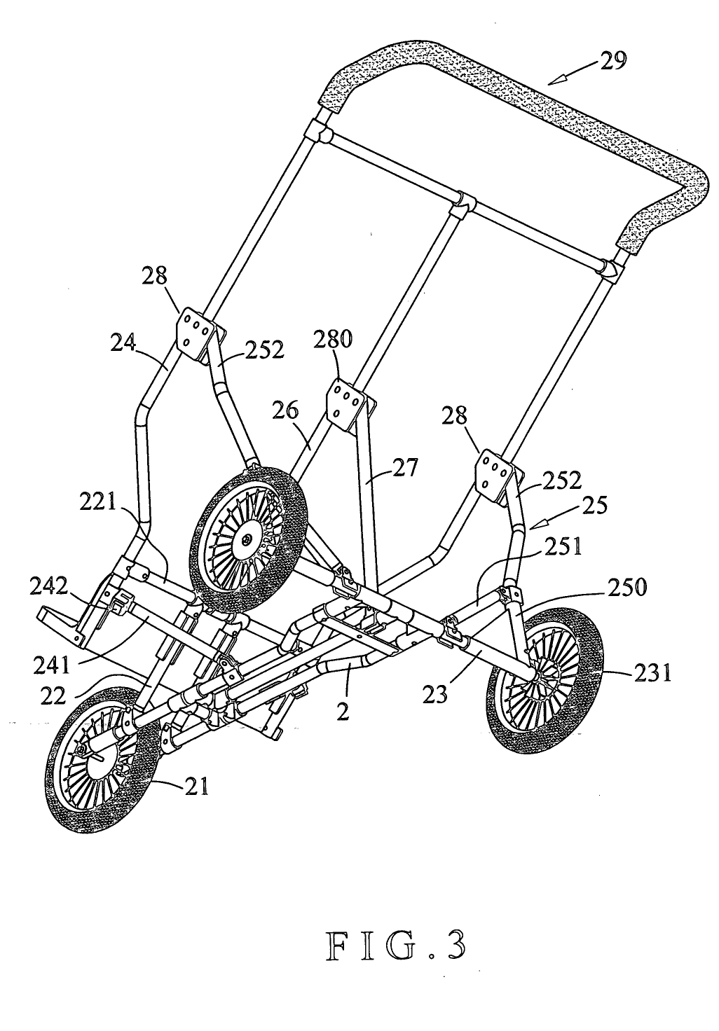

As shown in FIGS. 3-5, the skeleton further comprises two locking seats 242 each secured on a respective one of the two front support bars 24 to detachably lock an upper end of a respective one of the two front stretchers 241.

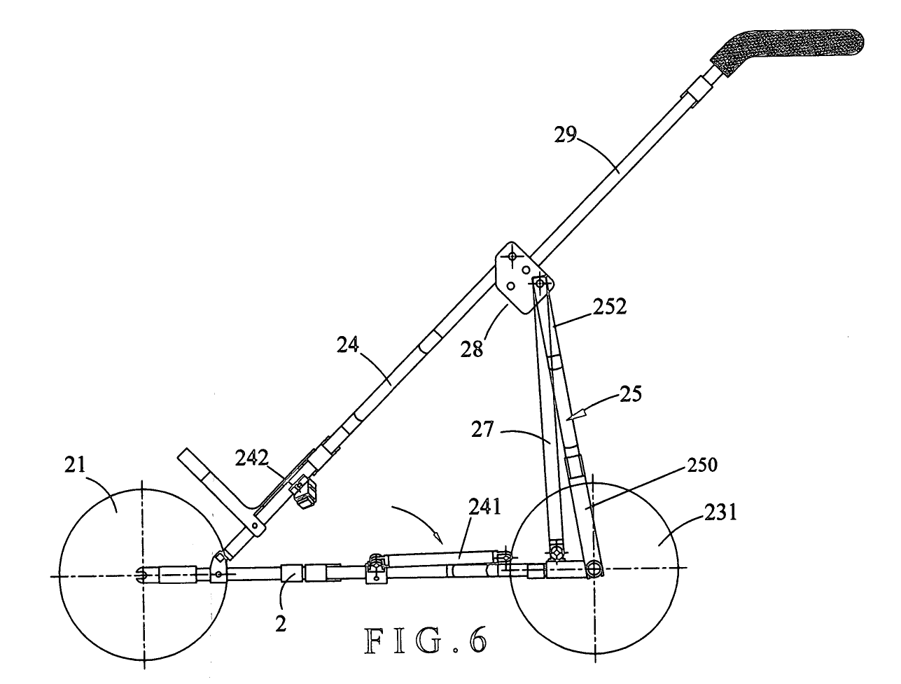

As shown in FIG. 6, when each of the two locking seats 242 is unlocked, each of the two front stretchers 241 is pivoted toward the bottom frame 2, so that each of the two front stretchers 241 is folded on the bottom frame 2.

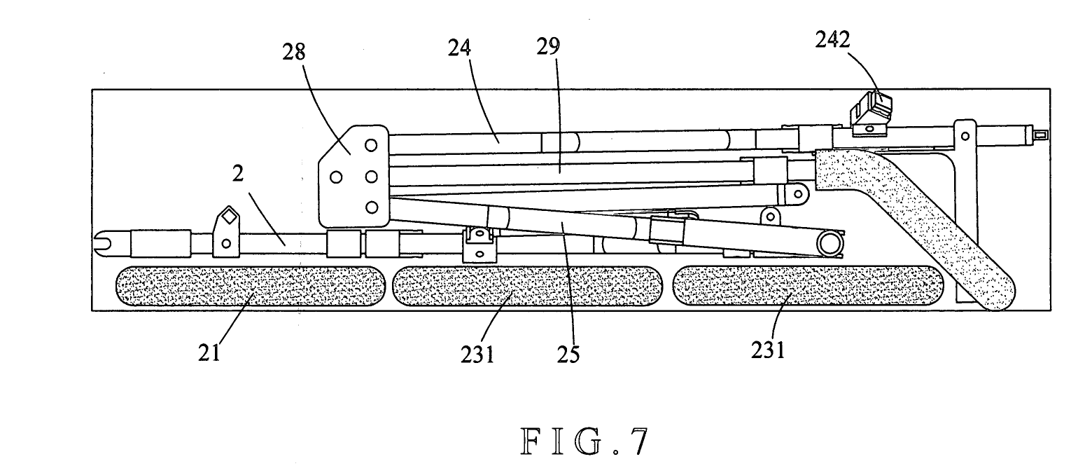

As shown in FIG. 7, after each of the two front stretchers 241 is folded on the bottom frame 2, the front wheel 21 and the rear wheels 231 are detached, so that the two front support bars 24, the two rear support bars 25, the front support rod 26 the rear support rod 27, and the push bar 29 are folded relative to each other, thereby folding the skeleton of the stroller.

Accordingly, the skeleton of the stroller is folded completely so as to reduce the volume, thereby facilitating storage, package and transportation. In addition, the first ends 250 of the two rear support bars 25 are bent inward toward the mediate portion of the wheel shaft 23, so that each of the two rear wheels 231 mounted on the wheel shaft 23 is shifted inward and is flush with the second end 252 of a respective one of the two rear support bars 25 so as to reduce the distance between the two rear wheels 231, thereby greatly reducing the whole width of the skeleton of the stroller.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A skeleton for a stroller, comprising:
a bottom frame;
two oblique rods each having a lower end pivotally mounted on the front end of the bottom frame;
a transverse rod mounted on an upper end of each of the two oblique rods;
a wheel shaft mounted on a rear end of the bottom frame;
two rear wheels pivotally mounted on two ends of the wheel shaft;
two front support bars each having a first end mounted on the transverse rod; and
two rear support bars each having a first end mounted on the wheel shaft and a second end pivotally connected with a second end of a respective one of the front support bars;
wherein, each of the two rear wheels mounted on the wheel shaft is flush with the second end of a respective one of the two rear support bars, thereby greatly reducing the whole width of the skeleton of the stroller.

2. The skeleton in accordance with claim 1, wherein the first ends of the two rear support bars are bent toward each other.

3. The skeleton in accordance with claim 1, wherein the first ends of the two rear support bars are bent inward toward a mediate portion of the wheel shaft.

4. The skeleton in accordance with claim 1, further comprising two oblique rear stretchers each pivotally mounted between the first end of a respective one of the two rear support bars and the mediate portion of the wheel shaft to enhance the supporting effect of the two rear support bars.

5. The skeleton in accordance with claim 1, wherein the further comprising two oblique front stretchers each pivotally mounted between a respective one of the two front support bars and the bottom frame to enhance the supporting effect of the front support bars.

6. The skeleton in accordance with claim 5, further comprising two locking seats each secured on a respective one of the two front support bars to detachably lock an upper end of a respective one of the two front stretchers.

7. The skeleton in accordance with claim 6, wherein when each of the two locking seats is unlocked, each of the two front stretchers is pivoted toward the bottom frame, so that each of the two front stretchers is folded on the bottom frame.

8. The skeleton in accordance with claim 1, further comprising a front wheel pivotally mounted on a front end of the bottom frame.

9. The skeleton in accordance with claim 1, wherein the second end of each of the two rear support bars is pivotally connected with the second end of a respective one of the front support bars by a pivot base.

10. The skeleton in accordance with claim 9, further comprising a push bar mounted on the pivot base.

11. The skeleton in accordance with claim 1, further comprising a front support rod having a first end mounted on the transverse rod, a rear support rod having a first end mounted on the wheel shaft and a second end pivotally connected with a second end of the front support rod by a pivot base.

12. The skeleton in accordance with claim 11, further comprising a push bar mounted on the pivot base.
